(19) United States
(12) Patent Application Publication
(10) Pub. No.: US 2024/0150536 A1
(43) Pub. Date: May 9, 2024

(54) BLOWING AGENTS COMPRISING Z-1-CHLORO-2,3,3,3-TETRAFLUOROPENTENE (HCFO-1224YD(Z))

(71) Applicant: Honeywell International Inc., Charlotte, NC (US)

(72) Inventors: Bin YU, Charlotte, NC (US); Alexey KRUGLOV, Charlotte, NC (US)

(21) Appl. No.: 18/552,841

(22) PCT Filed: Mar. 29, 2022
(86) PCT No.: PCT/US2022/071409

§ 371 Date: Sep. 27, 2023

Related U.S. Application Data
(60) Provisional application No. 63/167,950, filed on Mar. 30, 2021.

(51) Int. Cl. C08J 9/14

(52) U.S. Cl. CPC C08J 9/149; C08J 9/141; C08J 9/144; C08J 2203/14; C08J 2203/162; C08J 2203/182; C08J 2375/04

(57) ABSTRACT

The present disclosure provides blowing agents for polyurethane and polyisocyanurate foams, comprising Z-1-chloro-2,3,3,3-tetrafluoropentene (HCFO-1224yd(Z)) and cyclopentane in amounts of 65 wt. % to 99 wt. % and 1 wt. % to 35 wt. %, respectively. The present disclosure further provides foams formed from polyurethane or polyisocyanurate foams and blowing agents comprising Z-1-chloro-2,3,3,3-tetrafluoropentene (HCFO-1224yd(Z)) and cyclopentane having low initial lambda values.

### CROSS-REFERENCE TO RELATED APPLICATION

This application claims priority to U.S. Provisional Application No. 63/167,950, filed Mar. 30, 2021, which is herein incorporated by reference in its entirety.

### FIELD

The present disclosure pertains to mixtures comprising Z-1-chloro-2,3,3,3-tetrafluoropentene (HCFO-1224yd(Z)) and cyclopentane. The present disclosure further provides blowing agent mixtures comprising Z-1-chloro-2,3,3,3-tetrafluoropentene (HCFO-1224yd(Z)) and cyclopentane, methods for foaming using these compositions, and foams comprising these compositions.

### BACKGROUND

Fluorocarbon based fluids have found widespread use in industry in a number of applications, including as refrigerants, aerosol propellants, blowing agents, heat transfer media, gaseous dielectrics, and fire suppression.

The industry is continually seeking new fluorocarbon-based mixtures that offer alternatives, and are considered environmentally safer substitutes for CFCs, HCFCs and HFCs in use today. Of particular interest are mixtures containing hydrofluorocarbons, fluoroolefins, iodide containing compounds and other fluorinated compounds, which have low ozone depletion potentials and low global warming potentials. Such mixtures are the subject of this disclosure.

### SUMMARY

The present disclosure provides a foamable composition, comprising a foam forming agent and a blowing agent composition comprising a mixture of Z-1-chloro-2,3,3,3-tetrafluoropentene (HCFO-1224yd(Z)) and cyclopentane. The blowing agent composition may include cyclopentane in amounts of about 1 wt. % to about 35 wt. % and Z-1-chloro-2,3,3,3-tetrafluoropentene (HCFO-1224yd(Z)) in amounts of about 65 wt. % to about, 99 wt. % based on the combined weight of the Z-1-chloro-2,3,3,3-tetrafluoropentene (HCFO-1224yd(Z)) and cyclopentane. The foamable composition may comprise at least one of a polyurethane foam and an isocyanurate foam.

The present disclosure further provides foams formed using a blowing agent composition comprising a mixture of Z-1-chloro-2,3,3,3-tetrafluoropentene (HCFO-1224yd(Z)) and cyclopentane in amounts of 1 wt. % to 35 wt. % cyclopentane and 65 wt. % to 99 wt. % Z-1-chloro-2,3,3,3-tetrafluoropentene (HCFO-1224yd(Z)) based on the combined weight of Z-1-chloro-2,3,3,3-tetrafluoropentene (HCFO-1224yd(Z)) and cyclopentane. The initial lambda value of the foams may be 20.5 mW/mK or less.

### DESCRIPTION OF THE DRAWINGS

FIG. 1 is a graph of initial lambda versus mole percentage of cyclopentane in a polyurethane foam, as described in Example 1.

FIG. 2 is a graph of initial lambda versus mole percentage of cyclopentane in a polyisocyanurate foam, as described in Example 2.

### DETAILED DESCRIPTION

The present disclosure provides mixtures comprising Z-1-chloro-2,3,3,3-tetrafluoropentene (HCFO-1224yd(Z)) and cyclopentane, described in further detail below. The present disclosure also provides compositions, and particularly blowing agents, foamable compositions, foamed articles and methods and systems for forming foam, which utilize the mixtures of Z-1-chloro-2,3,3,3-tetrafluoropentene (HCFO-1224yd(Z)) and cyclopentane.

It has surprisingly been found that foams formed using blowing agents comprising a combination of Z-1-chloro-2,3,3,3-tetrafluoropentene (HCFO-1224yd(Z)) and cyclopentane display low initial lambda values when cyclopentane is added in amounts of about 1 wt. % to about 35 wt. % based on the combined weight of Z-1-chloro-2,3,3,3-tetrafluoropentene (HCFO-1224yd(Z)) and cyclopentane.

The amount cyclopentane may also be described as a mole percentage. Specifically, foams formed using blowing agents comprising a combination of Z-1-chloro-2,3,3,3-tetrafluoropentene (HCFO-1224yd(Z)) and cyclopentane display low initial lambda values when cyclopentane is added in amounts of about 1 mol % to about 50 mol % based on the combined of number of moles of Z-1-chloro-2,3,3,3-tetrafluoropentene (HCFO-1224yd(Z)) and cyclopentane.

As the use of hydrocarbons in blowing agent compositions are typically detrimental to initial lambda values in the resulting foams, one skilled in the art would expect that the addition of cyclopentane to a blowing agent composition including Z-1-chloro-2,3,3,3-tetrafluoropentene (HCFO-1224yd(Z)) would cause initial lambda values of the resulting foams to immediately rise in proportion to the amount of cyclopentane added to the blowing agent composition. However, it has been surprisingly found that initial lambda values of foams formed using Z-1-chloro-2,3,3,3-tetrafluoropentene (HCFO-1224yd(Z)) as a blowing agent remain substantially unchanged when cyclopentane is added to Z-1-chloro-2,3,3,3-tetrafluoropentene (HCFO-1224yd(Z)) in amounts of up to about 35 wt. %, based on the combined weight of Z-1-chloro-2,3,3,3-tetrafluoropentene (HCFO-1224yd(Z)) and cyclopentane.

This presents a significant commercial advantage in that Z-1-chloro-2,3,3,3-tetrafluoropentene (HCFO-1224yd(Z)) is relatively expensive as compared to cyclopentane, therefore, foams using mixtures of Z-1-chloro-2,3,3,3-tetrafluoropentene (HCFO-1224yd(Z)) and cyclopentane as the blowing agent may have desirable initial lambda values yet may be comparatively less expensive to produce than foams made using Z-1-chloro-2,3,3,3-tetrafluoropentene (HCFO-1224yd(Z)) alone as a blowing agent.

I. Blowing Agents Comprising Mixtures of Z-1-chloro-2,3,3,3-tetrafluoropentene (HCFO-1224yd(Z)) and cyclopentane

Fluorocarbon fluids have properties that are desirable for use in a variety of applications, including as blowing agents, and other applications. Unfortunately, the use of certain hydrofluorocarbons “HFCs” in industrial applications is now believed to contribute to the global warming, and accordingly, have limited their contemporary use. However, the identification of new, environmentally-safe compositions comprising HFCs is complicated, due to the fact that many properties which make them useful in these applications are not readily predictable. For example, it is desirable that blowing agent compositions not only have acceptable environmental properties, but also chemical stability, low- or no-toxicity, low or no-flammability, among others. It is also desirable that the blowing agent has excellent performance when in use, e.g. excellent thermal insulating properties and other desirable foam characteristics.

Methods and compositions for making conventional foamed materials, such as for example thermoplastic materials and thermosetting materials, have long been known. These methods and compositions have typically utilized chemical and/or physical blowing agents to form the foamed structure in a polymeric matrix. Such blowing agents have included, for example, azo compounds, various volatile organic compounds (VOCs) and chlorofluorocarbons (CFCs). The chemical blowing agents typically undergo some form of chemical change, including chemical reaction with the material that forms the polymer matrix (usually at a predetermined temperature/pressure) that causes the release of a gas, such as nitrogen, carbon dioxide, or carbon monoxide. One of the most frequently used chemical blowing agents is water. The physical blowing agents typically are dissolved in the polymer or polymer precursor material and then expand volumetrically (again at a predetermined temperature/pressure) to contribute to the formation of the foamed structure. Physical blowing agents are frequently used in connection with thermoplastic foams, although chemical blowing agents can be used in place of or in addition to physical blowing agents in connection with thermoplastic foam. It is common to use chemical blowing and/or physical blowing agents in connection with thermosetting foams. Of course, it is possible that certain compounds and the compositions that contain them may at once constitute a chemical and a physical blowing agent.

The blowing agents of the present disclosure may comprise a mixture of Z-1-chloro-2,3,3,3-tetrafluoropentene (HCFO-1224yd(Z)) and cyclopentane. Cyclopentane may be present in the mixture in an amount of about 1 wt. % or greater, about 5 wt. % or greater, about 10 wt. % or greater, about 15 wt. % or greater, about 20 wt. % or less, about 25 wt. % or less, about 30 wt. % or less, about 35 wt. % or less, or any value encompassed by these endpoints, based on the combined weight of Z-1-chloro-2,3,3,3-tetrafluoropentene (HCFO-1224yd(Z)) and cyclopentane. Z-1-Chloro-2,3,3,3-tetrafluoropentene (HCFO-1224yd(Z)) may be present in the mixture in an amount of about 65 wt. % or greater, about 70 wt. % or greater, about 75 wt. % or greater, about 80 wt. % or greater, about 85 wt. % or less, about 90 wt. % or less, about 95 wt. % or less, about 99 wt. % or less, or any value encompassed by these endpoints, based on the combined weight of Z-1-chloro-2,3,3,3-tetrafluoropentene (HCFO-1224yd(Z)) and cyclopentane.

When the blowing agent includes only Z-1-chloro-2,3,3,3-tetrafluoropentene (HCFO-1224yd(Z)) and cyclopentane, the percentages above are based on the total weight of the blowing agent composition.

Alternatively, the blowing agent may consist essentially of the mixture of Z-1-chloro-2,3,3,3-tetrafluoropentene (HCFO-1224yd(Z)) and cyclopentane. Alternatively, the blowing agent may consist of the mixture of Z-1-chloro-2,3,3,3-tetrafluoropentene (HCFO-1224yd(Z)) and cyclopentane.

When used as a blowing agent, the mixture of Z-1-chloro-2,3,3,3-tetrafluoropentene (HCFO-1224yd(Z)) and cyclopentane may be used in combination with one or more additional blowing agents, such as one or more of 1,1-difluoroethane (HFC-152a), 1,1,1,3,3-pentafluoropropane (HFC-245fa), 1,1,1,2-tetrafluoroethane (HFC-134a), 1,1,2,2,-tetrafluoroethane (HFC-134), 1,1,1,3,3-pentafluorobutane (HFC-365mfc), propane, butane, pentane, hexane, E-1,3,3,3-tetrafluoropropene (HFO-1234ze(E)), 2,3,3,3-tetrafluoropropene (HFO-1234yf), E-1,1,1,4,4,4-hexafluoro-2-butene (HFO-1336mzz(E)), Z-1,1,1,4,4,4-hexafluoro-2-butene (HFO-1336mzz(Z)), E-1-chloro-3,3,3-trifluoropropene (HFO-1233zd(E)), Z-1-chloro-3,3,3-trifluoropropene (HFO-1233zd(Z)), E-1-chloro-2,3,3,3-tetrafluoropentene (HCFO-1224yd(E)), 1,1-dichlro-2,3,3,3-tetrafluoropropene (HFO-1214ya), trans-dichloroethylene (trans-DCE), methyl formate, methylal, formic acid, acetic acid, C1-C4 aldehydes, C3-C4 ketones, C2-C4 ethers, diethers, water and combinations thereof.

When water is added, it will typically be present in an amount of less than 5 wt. %, such as 5 wt. % or less, 4 wt. % or less, 3 wt. % or less, 2 wt. % or less, or 1 wt. % or less.

II. Foamable Compositions Comprising the Mixture of Z-1-chloro-2,3,3,3-tetrafluoropentene (HCFO-1224yd(Z)) and cyclopentane

The present disclosure provides foamable compositions including a blowing agent composition such as those described above, and one or more components capable of forming foam. Specifically, the mixture is well suited for polyurethane and polyisocyanurate foam compositions. In principle, the mixture is added to a foamable composition, which may contain other components needed to react to make foam under specific reaction conditions.

As used herein, the term “foam forming agent” is used to refer to a component, or a combination of components, which are capable of forming a foam structure, preferably a generally cellular foam structure, not including additives such as flame retardants, surfactants, crossslinkers, de-frothing agents, solubility enhancer, fillers, dispersing agents, antibacterial agents, viscosity reduction modifiers, vapor pressure modifiers, colorants, and dyes, for example.

The one or more components capable of forming foam may be a composition capable of forming a thermosetting foam. Examples of thermosetting foams may include polyurethane and polyisocyanurate foam.

The present disclosure also relates to a closed cell foam comprising the blowing agent composition of the disclosure. The foam may be a rigid foam, a flexible foam, or an integral skin foam. Preferably, the disclosure relates to a closed cell rigid foam comprising the blowing agent composition comprising the mixture of Z-1-chloro-2,3,3,3-tetrafluoropentene (HCFO-1224yd(Z)) and cyclopentane described above.

The foam provided by the present disclosure can be a block, a slab, a laminate, a panel, such as a pour-in-place panel, a spray applied foam, a froth, and the like. The foams described in the present disclosure, particularly thermoset foams disclosed herein, may be used in a wide variety of applications, in certain preferred embodiments the present disclosure comprises appliance foams in accordance with the present disclosure, including appliance foams, such as refrigerator foams, freezer foams, refrigerator/freezer foams; panel foams; and other cold or cryogenic manufacturing applications.

The foams of the present disclosure are particularly provided for use in appliance, refrigeration, transportation and building industries (for example as building envelopes). The foams described herein provide one or more exceptional features, characteristics and/or properties, including: thermal insulation efficiency (particularly for thermoset foams), dimensional stability, compressive strength, aging of thermal insulation properties, and flame retardancy, among others, all in addition to the low global warming potential associated with the blowing agents of the present disclosure.

The foam may be a thermoset foam or a thermoplastic foam. The thermoplastic foam is may be polyethylene (PE), polypropylene (PP), polystyrene (PS) or polyethyleneterepthalate (PET). The thermoset foam may be a polyisocyanurate (PIR) or polyurethane (PU) foam.

The blowing agent of the present disclosure may be present in the foamable composition in an amount of about 2 wt. % or greater, about 3 wt. % or greater, about 4 wt. % or greater, about 5 wt. % or greater, about 6 wt. % or greater, about 7 wt. % or greater, about 8 wt. % or less, about 9 wt. % or less, about 10 wt. % or less, about 11 wt. % or less, about 12 wt. % or less, about 13 wt. % or less, about 14 wt. % or less, about 15 wt. % or less, or within any range encompassing these endpoints, as a percentage of the total weight of the foamable composition. The total weight of the foamable composition includes all components of the thermoplastic and thermoset foams.

### III. Method of Forming Foams

It is contemplated that all presently known and available methods and systems for forming foam are readily adaptable for use in connection with the compositions of the present disclosure. For example, the methods of the present disclosure generally incorporate a blowing agent into a foamable composition and then foaming the composition, preferably by a step or series of steps which include causing volumetric expansion of the blowing agent described herein. In general, it is contemplated that the presently used systems and devices for incorporation of blowing agent and for foaming can readily be used in accordance with the compositions of the present disclosure. In fact, it is believed that one advantage of the present disclosure is the provision of an improved blowing agent which is generally compatible with existing foaming methods and systems.

Thus, it will be appreciated by those skilled in the art that the present disclosure comprises methods and systems for foaming all types of foams, including thermosetting foams, and thermoplastic foams. Thus, the present disclosure relates to the use of the present blowing agents in connection with conventional foaming equipment at conventional processing conditions. The present methods therefore include masterbatch type operations, blending type operations, third stream blowing agent addition, and blowing agent addition at the mixing head.

With respect to thermoplastic foams, the preferred methods generally comprise introducing a blowing agent into a thermoplastic material, preferably a thermoplastic polymer, and then subjecting the thermoplastic material to conditions effective to cause foaming.

For example, the step of introducing the blowing agent into the thermoplastic material may comprise introducing the blowing agent into an extruder (e.g. a screw extruder) containing the thermoplastic, and the step of causing foaming may comprise lowering the pressure on the thermoplastic material and thereby causing expansion of the blowing agent and contributing to the foaming of the material.

It will be appreciated by those skilled in the art, especially in view of the disclosure contained herein, that the order and manner in which the blowing agent of the present disclosure is formed and/or added to the foamable composition does not generally affect the operability of the present disclosure. For example, in the case of extrudable foams, it is possible that the various components of the blowing agent, and even the components of the foamable composition, are not mixed in advance of introduction to the extrusion equipment, or even that the components are not added to the same location in the extrusion equipment. Moreover, the blowing agent can be introduced either directly or as part of a premix, which is then further added to other parts of the foamable composition.

Thus, it may be desirable to introduce one or more components of the blowing agent at first location in the extruder, which is upstream of the place of addition of one or more other components of the blowing agent, with the expectation that the components will come together in the extruder and/or operate more effectively in this manner. Nevertheless, it may be preferred that two or more components of the blowing agent are combined in advance and introduced together into the foamable composition, either directly or as part of premix which is then further added to other parts of the foamable composition.

The present disclosure also relates to methods of forming thermoset foams, such as polyurethane (PU) or polyisocyanurate (PIR). The methods generally comprise providing a blowing agent composition of the present disclosure, adding (directly or indirectly) the blowing agent composition to a foamable composition, and reacting the foamable composition under the conditions effective to form a foam or cellular structure, as is well known in the art. Any of the methods well known in the art, such as those described in “Polyurethanes Chemistry and Technology,” Volumes I and II, Saunders and Frisch, 1962, John Wiley and Sons, New York, NY, which is incorporated herein by reference, may be used in accordance with the present disclosure. In general, such preferred methods comprise preparing thermoset (e.g. polyurethane, or polyisocyanurate foams) by combining an isocyanate, a polyol or mixture of polyols, a blowing agent composition of the present disclosure, and optionally other materials such as catalysts, surfactants, flame retardants, colorants, or other additives.

It is convenient to provide the components for polyurethane or polyisocyanurate foams in pre-blended formulations. Most typically, the pre-blended formulation is pre-blended into two components. The isocyanate and optionally certain surfactants comprise the first component, commonly referred to as the “A” component. The polyol or polyol mixture, surfactants, catalysts, flame retardants comprise the second component, commonly referred to as the “B” component. The blowing agent composition may be present in the A component and/or the B component. For example, if the blowing agent composition comprises two blowing agents, the first blowing agent may be present in the A component, and the second blowing agent may be present in the B component.

The mixture of Z-1-chloro-2,3,3,3-tetrafluoropentene (HCFO-1224yd(Z)) and cyclopentane may be present in the polyol preblend mixture (B component) in an amount of about 10 wt. % or greater, about 15 wt. % or greater, about 20 wt. % or less, about 25 wt. % or less, about 30 wt. % or less, or any value encompassed by these endpoints, as a percentage of the total polyol preblend resin (B component).

The polyol preblend mixture of the present disclosure may include additional components. Such optional additional compounds include, but are not limited to, optionally other blowing agent such as E-1-chloro-2,3,3,3-tetrafluoropropene (HCFO-1224yd(E), Z-1,1,1,4,4,4-hexafluoro-2-butene (HFO-1336mzz(Z)), E-1,1,1,4,4,4-hexafluoro-2-butene (HFO-1336mzz(E), E-1-chloro-3,3,3-trifluropropene (HFO-1233zd(E), 1,1-dichloro-2,3,3,3-tetrafluoropropene (HFO-1214ya), E-1,3,3,3-tetrafluoropropene (1234ze(E), 2,3,3,3-tetrafluoropropene (HFO-1234yf), and 1,1-dichloro-2,2,-difluoroethylene (HFO-1112); hydrocarbons such as iso-pentane, and n-pentane; hydrofluorocarbons such as 1,1,1,3,3-pentafluoropropane (HFC-245fa) and 1,1,1,3,3-pentafluorobutane (HFC-365mfc); organic acids such as formic acid and acetic acid); various polyols; water; catalysts such as amine catalysts or metal catalysts; flame retardants such as organic flame retardants and/or inorganic flame retardants; surfactants (silicon or non-silicone); crossslinkers; de-frothing agents; solubility enhancers; fillers; dispersing agents; antibacterial agents; viscosity reduction modifiers; vapor pressure modifiers; colorants; and dyes.

Suitable polyols may include sucrose-containing polyols; phenol, a phenol formaldehyde-containing polyol; a glucose-containing polyol; a sorbitol-containing polyol; a methylglucoside-containing polyol; an aromatic amine-containing polyol, such as an ortho-toluene diamine (o-TDA)-containing polyol; an aromatic polyester polyol; glycerol; ethylene glycol; diethylene glycol; propylene glycol; one or more of (a) condensed with one or more of (b), wherein (a) is selected from glycerine, ethylene glycol, diethylene glycol, trimethylolpropane, ethylene diamine, pentaerythritol, soy oil, lecithin, tall oil, palm oil, and castor oil; and (b) is selected from ethylene oxide, propylene oxide, a mixture of ethylene oxide and propylene oxide; and combinations thereof, for example.

Suitable catalysts may include amine catalysts and/or metal catalysts. Amine catalysts may include, but are not limited to, primary amine, secondary amine or tertiary amine. Useful tertiary amine catalysts non-exclusively include N,N-dimethylcyclohexylamine, N,N-dimethylethanolamine, dimethylaminoethoxyethanol, N,N,N′-trimethylaminoethyl-ethanolamine, N,N,N′-trimethyl-N′-hydroxyethylbisaminoethylether, tetramethyliminobispropylamine, 2-[[2-[2-(dimethylamino)ethoxy]ethyl] methylamino] ethanol, pentamethyldiethylene-triamine, pentamethyldipropylenetriamine, N,N,N′,N″,N″-pentamethyl-dipropylenetriamine, 1,1,4,7,10,10-hexamethyltriethylenetetramine, N,N-bis(3-dimethylaminopropyl)-N-isopropanolamine, N′-(3-(dimethylamino)propyl)-N,N-dimethyl-1,3-propanediamine, bis(3-dimethylaminopropyl)-N,N-dimethylpropanediamine, bis-(2-dimethylaminoethyl)ether, N,N′,N″-dimethylaminopropylhexahydrotriazine, tetramethyliminobispropylamine, trimethyl-N′,2-hydroxyethyl-propylenediamine, bis-(3-aminopropyl)-methylamine, N,N-dimethyl-1,3-propanediamine, 1-(dimethylamino)hexadecane, benzyldimethylamine, 3-dimethylaminopropyl urea, dicyclohexylmethylamine; ethyldiisopropylamine; dimethylisopropylamine; methylisopropylbenzylamine; methylcyclopentylbenzylamine; isopropyl-sec-butyl-trifluoroethylamine; diethyl-(α-phenylethyl)amine, tri-n-propylamine, or combinations thereof. Useful secondary amine catalysts non-exclusively include dicyclohexylamine; tert-butylisopropylamine; di-tert-butylamine; cyclohexyl-tert-butylamine; di-sec-butylamine, dicyclopentylamine; di-(α-trifluoromethylethyl)amine; di-(α-phenylethyl)amine; or combinations thereof, for example.

Metal catalysts may include potassium catalysts, such as potassium octoate (Dabco K15) and potassium acetate (Polycat 46), for example; tin catalysts, such as dibutyltin dilaurylmercaptide (Dabco T120, Fomrez UL-1), dibutyltin diisooctylmaleate (Dabco T125), dimethyltin dilaurylmercaptide (Fomrez UL-22), dioctyltin dilaurylmercaptide Fomrez UL-32), and dibutyltin di-(2-ethylhexylthioglycolate) (Fomrez UL-6), for example; and bismuth carboxylate, such as Bicat 8108, Bicat 8210, and the like, for example.

Suitable isocyanates may include any organic polyisocyanurate which can be employed in polyurethane or polyisocyanurate foam synthesis inclusive of aliphatic and aromatic polyisocyanurate. Suitable organic polyisocyanurates include aliphatic, cycloaliphatic, araliphatic, aromatic, and heterocyclic isocyanates which are well known in the field of polyurethane chemistry. These are described in, for example, U.S. Pat. Nos. 4,868,224; 3,401,190; 3,454,606; 3,277,138; 3,492,330; 3,001,973; 3,394,164; 3,124,605; and 3,201,372.

Certain surfactants are added to serve as cell stabilizers. Some representative materials are sold under the names of DC-193, B-8404, and L-5340 which are, generally, polysiloxane polyoxyalkylene block co-polymers such as those disclosed in U.S. Pat. Nos. 2,834,748, 2,917,480, and 2,846,458, each of which is incorporated herein by reference. Other optional additives for the polyol pre-blend may include flame retardants such as tri(2-chloroethyl)phosphate, tri(2-chloropropyl)phosphate, tri(2,3-dibromopropyl)-phosphate, tri(1,3-dichloropropyl) phosphate, other halogen-free phosphates such as triethyl phosphate, butyl 3-(6-oxidodibenzo[c,e][1,2]oxaphosphinin-6-yl)propionate; (ammonium polyphosphate, various halogenated aromatic compounds, antimony oxide, aluminum trihydrate, polyvinyl chloride, and the like.

The polyurethane or polyisocyanurate foams are readily prepared by bringing together the A and B side components by mixing to form a foam, for example blocks, slabs, laminates, pour-in-place panels and other items, spray applied foams, froths, and the like. The mixing may be by hand mix e.g. for small preparations or machine mixing techniques.

The present methods and systems also include forming a one component thermoset foam, preferably polyurethane foam, containing a blowing agent in accordance with the present disclosure. A portion of the blowing agent may be contained in the foam forming agent of the one component foam, preferably by being dissolved in the foam forming agent which is liquid at the pressure within the container, and a second portion of the blowing agent may be present as a separate gas phase. In such systems, the contained/dissolved blowing agent performs, in large part, to cause the expansion of the foam, and the separate gas phase operates to impart propulsive force to the foam forming agent. Such one component systems are typically and preferably packaged in a container, such as an aerosol type can, and the blowing agent of the present disclosure thus preferably provides for expansion of the foam and/or the energy to transport the foam/foamable material from the package, and preferably both. Such systems and methods may comprise charging the package with a fully formulated system (preferably isocyanate/polyol system) and incorporating a gaseous blowing agent in accordance with the present disclosure into the package, preferably an aerosol type can.

### IV. Foams

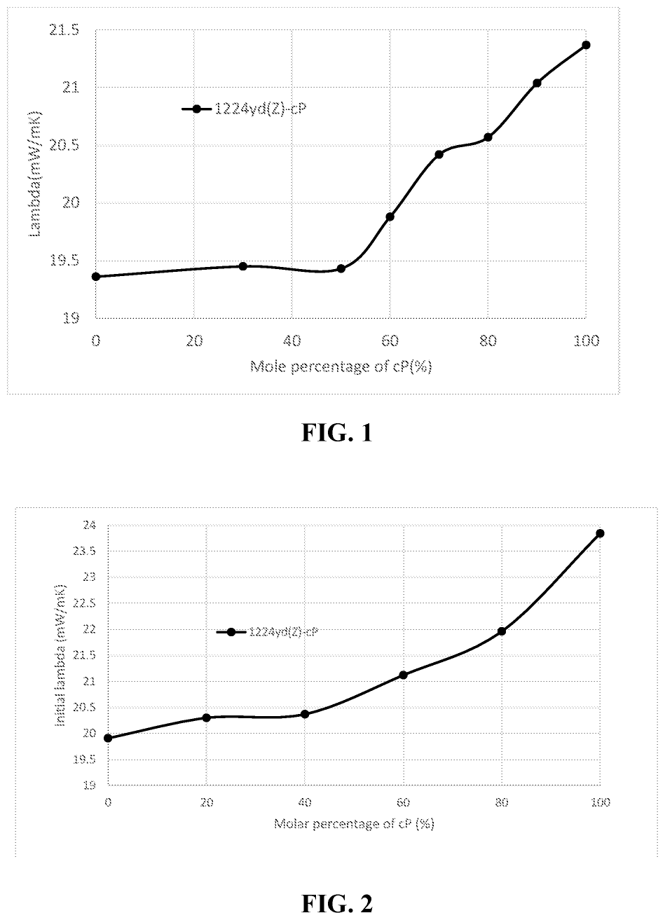

As discussed above, it has surprisingly been found that foams formed using blowing agents comprising Z-1-chloro-2,3,3,3-tetrafluoropentene (HCFO-1224yd(Z)) and cyclopentane display low lambda values. Specifically, when cyclopentane in an amount of up to 35 wt. % to Z-1-chloro-2,3,3,3-tetrafluoropentene (HCFO-1224yd(Z)), initial lambda does not increase appreciably, as shown in FIG. 1. Given the high initial lambda values of hydrocarbons in general and cyclopentane specifically, it would be expected that initial lambda values of Z-1-chloro-2,3,3,3-tetrafluoropentene (HCFO-1224yd(Z)) would immediately increase upon addition of cyclopentane. However, as disclosed herein, initial lambda values remain essentially unchanged upon addition of up about 33 wt. % cyclopentane.

When the mixtures of Z-1-chloro-2,3,3,3-tetrafluoropentene (HCFO-1224yd(Z)) and cyclopentane disclosed herein are used as blowing agents in polyurethane or polyisocyanurate foams, initial lambda (at a mean temperature of 10° C.) may be 19 mW/mK or greater, 19.2 mW/mK or greater, 19.4 mW/mK or greater, 19.6 mW/mK or greater, 19.8 mW/mK or less, 20.0 mW/mK or less, 20.2 mW/mK or less, 20.4 mW/mK or less, 20.5 mW/mK or less, or any value encompassed by these values.

The foams of the present disclosure may be in the form of blocks, slabs, or laminates, for example. The foams of the present disclosure may be used as appliance foams, such as in refrigerators, freezers, coolers, refrigerated trucks, railcars, and water heaters, for example. The foams of the present disclosure may be used in foam core metal panels. These foam core metal panels can be manufactured by either continuous or discontinuous production methods and both of such methods are adaptable for use within the scope of the present disclosure. In the construction industry, such articles in the form of rigid panels may be employed as insulation in the building envelope of commercial structures.

Any of the methods well known in the art, such as those described in “Polyurethanes Chemistry and Technology,” Volumes I and II, Saunders and Frisch, 1962, John Wiley and Sons, New York, NY, which is incorporated herein by reference, may be used or adapted for use in accordance with the foam forming embodiments of the present disclosure.

The following non-limiting example serves to illustrate the disclosure.

### EXAMPLES

All foams (polyisocyanurate (PIR) and polyurethane (PU)) were formulated using the following starting materials: Stepanpol PS 2352, available from Stepan (polyester polyol, hydroxy number: 240 mg KOH/g, functionality: 2); Voranol 490, available from Dow (sucrose/glycerin initiated polyether polyol, hydroxy number: 490 mg KOH/g, functionality: 4.3); Voranol 391, available from Dow (amine (ortho-diaminotoluene) initiated polyol, hydroxy number: 395 mg KOH/g, functionality: 4); Voranol 270, available from Dow (glycerine initiated polyether polyol, hydroxy number: 238 mg KOH/g, functionality: 3); Terate HT5510 (“HT5510”), available from Invista (aromatic polyester polyol, hydroxy number: 260 mg KOH/g, functionality: 2); Tegostab B84210 (“B84210”) (silicon surfactant from Evonik); Tegostab B8465 (“B8465”) (silicon surfactant from Evonik); Dabco K15 (“K15”) (potassium-octoate in diethylene glycol from Evonik); Polycat 8 (N,N-dimethylcyclohexylamine from Evonik); Polycat 5 (pentamethyldiethylenetriamine from Evonik); Polycat 41 (1,3,5-tris[3-(dimethylamino)propyl]hexahydro-1,3,5-triazine from Evonik); Lupranate M20 available from BASF (polymeric isocyanate, 31.5% NCO, functionality: 2.7); TCPP (Tris (1-chloro-2-propyl) phosphate) phosphorus content: 9.4 wt. %; chlorine content: 33 wt. %.

The foam was formulated by hand mixing based on the formulations described in the Examples below. The lambda value was recorded using the LaserComp FOX50 with a sample size of 12″×12″×1″.

### Example 1: Z-1-chloro-2,3,3,3-tetrafluoropropene (HCFO-1224yd(Z)) and cyclopentane in polyurethane foam

Various mixtures of Z-1-chloro-2,3,3,3-tetrafluoropropene (HCFO-1224yd(Z)) and cyclopentane were used as blowing agents in polyurethane foams, which were tested in for their initial lambda values. The compositions of the different foams are shown below in Table 1, with each component shown as parts per hundred (php) of the polyol.

TABLE 1

| Component | Run 1 | Run 2 | Run 3 | Run 4 | Run 5 | Run 6 | Run 7 | Run 8 |
|---|---|---|---|---|---|---|---|---|
| Voranol 391 | 40 | 40 | 40 | 40 | 40 | 40 | 40 | 40 |
| HT5510 | 20 | 20 | 20 | 20 | 20 | 20 | 20 | 20 |
| Voranol 490 | 32 | 32 | 32 | 32 | 32 | 32 | 32 | 32 |
| Voranol 270 | 8 | 8 | 8 | 8 | 8 | 8 | 8 | 8 |
| B84210 | 4 | 4 | 4 | 4 | 4 | 4 | 4 | 4 |
| Polycat 5 | 0.5 | 0.5 | 0.5 | 0.5 | 0.5 | 0.5 | 0.5 | 0.5 |
| Polycat 8 | 2.5 | 2.5 | 2.5 | 2.5 | 2.5 | 2.5 | 2.5 | 2.5 |
| Polycat 41 | 0.8 | 0.8 | 0.8 | 0.8 | 0.8 | 0.8 | 0.8 | 0.8 |
| Water | 1.8 | 1.8 | 1.8 | 1.8 | 1.8 | 1.8 | 1.8 | 1.8 |
| Cyclopentane | 0 | 5.01 | 8.35 | 10.02 | 11.68 | 13.35 | 15.02 | 16.69 |
| HCFO- | 35.29 | 24.70 | 17.65 | 14.116 | 10.59 | 7.06 | 3.53 | 0 |
| 1224yd(Z) | | | | | | | | |
| Lupranate | 124.7 | 124.7 | 124.7 | 124.7 | 124.7 | 124.7 | 124.7 | 124.7 |
| M20 | | | | | | | | |

Each of the foams formed was then tested for initial lambda using the methods described in ASTM C518. The initial lambda values were roughly 19.5 mW/mK or less when mixtures of from 1 wt. % to 35 wt. % cyclopentane and from 65 wt. % to 99 wt. % Z-1-chloro-2,3,3,3-tetrafluoropene (HCFO-1224yd(Z)) were used as the blowing agent, and began to rise upon addition of greater amounts of cyclopentane. These results are shown in graphical form in FIG. 1.

### Example 2: Z-1-chloro-2,3,3,3-tetrafluoropene (HCFO-1224yd(Z)) and cyclopentane in polyisocyanurate foam

Various mixtures of Z-1-chloro-2,3,3,3-tetrafluoropropene (HCFO-1224yd(Z)) and cyclopentane were used as blowing agents in polyisocyanurate foams, which were tested in for their initial lambda values. The compositions of the different foams are shown below in Table 2. All values are shown in parts per hundred (php) of the polyol.

TABLE 2

| Component | Run 1 | Run 2 | Run 3 | Run 4 | Run 5 | Run 6 |
|---|---|---|---|---|---|---|
| Stepanpol PS | 100 | 100 | 100 | 100 | 100 | 100 |
| 2352 | | | | | | |
| K15 | 1.6 | 1.6 | 1.6 | 1.6 | 1.6 | 1.6 |
| Polycat 8 | 0.5 | 0.5 | 0.5 | 0.5 | 0.5 | 0.5 |
| Polycat 5 | 0.3 | 0.3 | 0.3 | 0.3 | 0.3 | 0.3 |
| B8465 | 2 | 2 | 2 | 2 | 2 | 2 |
| Water | 0.8 | 0.8 | 0.8 | 0.8 | 0.8 | 0.8 |
| TCPP | 15 | 15 | 15 | 15 | 15 | 15 |
| HCFO- | 37.6 | 30.1 | 22.5 | 15.01 | 7.5 | 0 |
| 1224yd(Z) | | | | | | |
| Cyclopentane | 0 | 3.6 | 7.1 | 10.7 | 14.2 | 17.8 |
| Lupranate | 207.7 | 207.7 | 207.7 | 207.7 | 207.7 | 207.2 |
| M20 | | | | | | |

Initial lambda was then tested for each of the foams formed. The initial lambda values were roughly 20.5 mW/mK or less when mixtures of from 1 wt. % to 24 wt. % cyclopentane and from 76 wt. % to 99 wt. % Z-1-chloro-2,3,3,3-tetrafluoropene (HCFO-1224yd(Z)) were used as the blowing agent, and began to rise upon addition of greater amounts of cyclopentane. These results are shown in graphical form in FIG. 2.

### ASPECTS

Aspect 1 is a foamable composition comprising a foam forming agent, and a blowing agent composition comprising a mixture of Z-1-chloro-2,3,3,3-tetrafluoropentene (HCFO-1224yd(Z)) and cyclopentane in amounts of 1 wt. % to 35 wt. % cyclopentane and 65 wt. % to 99 wt. % Z-1-chloro-2,3,3,3-tetrafluoropentene (HCFO-1224yd(Z)) based on the combined weight of the Z-1-chloro-2,3,3,3-tetrafluoropentene (HCFO-1224yd(Z)) and cyclopentane.

Aspect 2 is the foamable composition of Aspect 1, wherein the foam forming agent comprises at least one of a polyurethane foam and a polyisocyanurate foam.

Aspect 3 is the foamable composition of either Aspect 1 or Aspect 2, further comprising at least one surfactant.

Aspect 4 is the foamable composition of any one of Aspects 1-3, further comprising at least one catalyst.

Aspect 5 is the foamable composition of any one of Aspects 1-4, further comprising at least one flammability suppressant.

Aspect 6 is the foamable composition of any one of Aspects 1-5, further comprising at least one adjuvant selected from the group consisting of: polymer modifier(s), toughening agent(s), colorant(s), dye(s), solubility enhancer(s), rheology modifier(s), plasticizing agent(s), antibacterial agent(s), viscosity reduction modifier(s), filler(s), vapor pressure modifier(s), and combination of any two or more of these.

Aspect 7 is a foam formed from a foam forming agent; and a blowing agent composition comprising a mixture of Z-1-chloro-2,3,3,3-tetrafluoropentene (HCFO-1224yd(Z)) and cyclopentane in amounts of 1 wt. % to 35 wt. % cyclopentane and 65 wt. % to 99 wt. % Z-1-chloro-2,3,3,3-tetrafluoropentene (HCFO-1224yd(Z)) based on the combined weight of Z-1-chloro-2,3,3,3-tetrafluoropentene (HCFO-1224yd(Z)) and cyclopentane.

Aspect 8 is the foam according to Aspect 7, wherein the foam forming agent comprises a polyurethane foam or a polyisocyanurate foam.

Aspect 9 is the foam according to either Aspect 7 or Aspect 8, wherein the initial lambda value of the foam is 20.5 mW/mK or less.

Aspect 10 is a block comprising the foam according to any one of Aspects 7-9.

Aspect 11 is a slab comprising the foam according to any one of Aspects 7-9.

Aspect 12 is a laminate comprising the foam according to any one of Aspects 7-9.

Aspect 13 is the foam according to any one of Aspects 7-9 in the form of an appliance foam.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

As used herein, the singular forms “a”, “an” and “the” include plural unless the context clearly dictates otherwise. Moreover, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the disclosure be limited to the specific values recited when defining a range.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances that fall within the scope of the appended claims.

1-13. (canceled)

14. A foamable composition comprising:
a foam forming agent; and
a blowing agent composition comprising:
a mixture of Z-1-chloro-2,3,3,3-tetrafluoropentene (HCFO-1224yd(Z)) and cyclopentane in amounts of 1 wt. % to 35 wt. % cyclopentane and 65 wt. % to 99 wt. % Z-1-chloro-2,3,3,3-tetrafluoropentene (HCFO-1224yd(Z)) based on the combined weight of the Z-1-chloro-2,3,3,3-tetrafluoropentene (HCFO-1224yd(Z)) and cyclopentane.

15. The foamable composition of claim 14, wherein the foam forming agent comprises at least one of a polyurethane foam and a polyisocyanurate foam.

16. The foamable composition of claim 15 further comprising at least one surfactant.

17. The foamable composition of claim 16 further comprising at least one catalyst.

18. The foamable composition of claim 17 further comprising at least one flammability suppressant.

19. The foamable composition of claim 14 further comprising at least one adjuvant selected from the group consisting of: polymer modifier(s), toughening agent(s), colorant(s), dye(s), solubility enhancer(s), rheology modifier(s), plasticizing agent(s), antibacterial agent(s), viscosity reduction modifier(s), filler(s), vapor pressure modifier(s), and combination of any two or more of these.

20. A foam formed from:
a thermosetting foam forming agent; and
a blowing agent composition comprising:
a mixture of Z-1-chloro-2,3,3,3-tetrafluoropentene (HCFO-1224yd(Z)) and cyclopentane in amounts of 1 wt. % to 35 wt. % cyclopentane and 65 wt. % to 99 wt. % Z-1-chloro-2,3,3,3-tetrafluoropentene (HCFO-1224yd(Z)) based on the combined weight of Z-1-chloro-2,3,3,3-tetrafluoropentene (HCFO-1224yd(Z)) and cyclopentane.

21. The foam according to claim 20, wherein the thermosetting foam forming agent comprises a polyurethane foam or a polyisocyanurate foam and wherein the initial lambda value of the foam is 20.5 mW/mK or less.

22. A panel foam comprising the foam according to claim 21.

23. An appliance foam comprising the foam according to claim 21.

24. A slab comprising the foam according to claim 21.

25. A laminate comprising the foam according to claim 21.

26. The foam according to claim 20 in the form of an appliance foam.

27. A method of forming an appliance foam comprising:
(a) providing a foamable composition comprising: (i) a thermosetting foam forming agent;
and (ii) a blowing agent composition comprising:
a mixture of Z-1-chloro-2,3,3,3-tetrafluoropentene (HCFO-1224yd(Z)) and cyclopentane in amounts of 1 wt. % to 35 wt. % cyclopentane and 65 wt. % to 99 wt. % Z-1-chloro-2,3,3,3-tetrafluoropentene (HCFO-1224yd(Z)) based on the combined weight of Z-1-chloro-2,3,3,3-tetrafluoropentene (HCFO-1224yd(Z)) and cyclopentane; and
(b) foaming said foamable composition to provide an appliance foam.

28. The method of claim 27 wherein the thermosetting foam forming agent comprises at least one of a polyurethane foam and a polyisocyanurate foam.

29. The method of claim 28 wherein said foamable composition further comprises at least one surfactant.

30. The method of claim 28 wherein said foamable composition further comprises at least one catalyst.

31. The method of claim 28 wherein said foamable composition further comprises at least one flammability suppressant.

32. The method of claim 28 wherein the initial lambda value of the foam is 20.5 mW/mK or less.

33. The method of claim 28 wherein the initial lambda value of the foam is 19.8 mW/mK or less.
